(19) United States
(12) Patent Application Publication
(10) Pub. No.: US 2011/0254824 A1
(43) Pub. Date: Oct. 20, 2011

(54) ELECTRONIC DEVICE WITH DUAL DISPLAY SCREENS

(75) Inventors: PING-YANG CHUANG, Tu-Cheng (TW); CHIH-MING CHANG, Tu-Cheng (TW)

(73) Assignee: HON HAI PRECISION INDUSTRY CO., LTD., Tu-Cheng (TW)

(21) Appl. No.: 12/953,484

(22) Filed: Nov. 24, 2010

(30) Foreign Application Priority Data
Apr. 16, 2010 (CN) 201010148898.9

(51) Int. Cl. G09G 5/00; G09G 3/36

(52) U.S. Cl. 345/212; 345/87

(57) ABSTRACT

An electronic device includes a liquid crystal display (LCD) screen, an electronic paper display (EPD) screen, storage, a switch module, and a CPU. The LCD screen is configured to display a primary user interface when the electronic device powers on. The EPD screen is configured to display predefined content stored in the storage set when the electronic device powers off. The switch module is configured to power the electronic device on or off in response to user input, and generate a corresponding control signal. The CPU is configured to register the control signal send by the switch module. When the control signal is the power off signal, the CPU directs the EPD screen to display the predefined content.

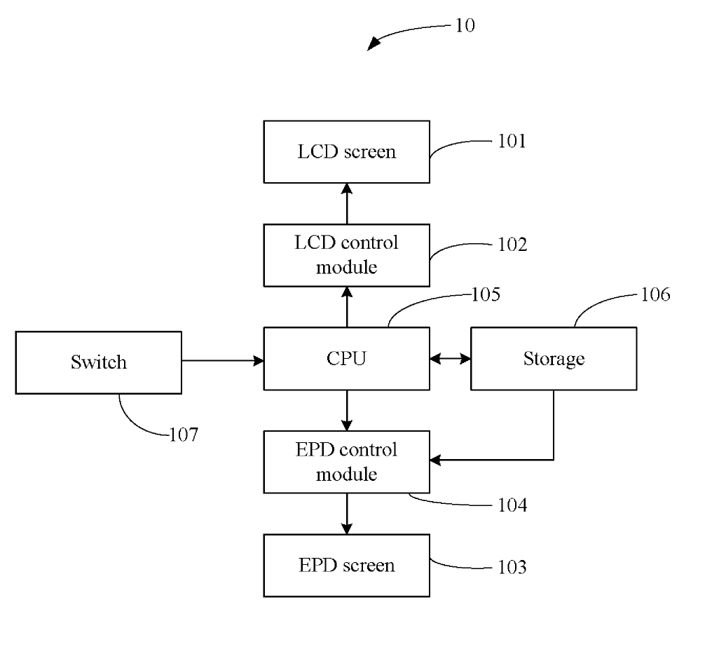

### BACKGROUND

1. Technical Field

The present disclosure relates to electronic devices and, particularly, to an electronic device with dual display screens.

2. Description of the Related Art

Commonly, to display basic system information, such as current time, user name, and others, electronic devices must be powered up to let the system run. It is a waste of power for the electronic devices.

Therefore, what is needed is an electronic device to overcome the described limitations.

### BRIEF DESCRIPTION OF THE DRAWINGS

The components in the drawings are not necessarily drawn to scale, the emphasis instead being placed upon clearly illustrating the principles of an electronic device with dual display screens. Moreover, in the drawings, like reference numerals designate corresponding parts throughout the several views.

The FIGURE is a block diagram of an electronic device with dual display screens, in accordance with an exemplary embodiment.

### DETAILED DESCRIPTION

Referring to the FIGURE, an electronic device 10 includes a liquid crystal display (LCD) screen 101, an LCD control module 102, an electronic paper display (EPD) screen 103, an EPD control module 104, a central processing unit (CPU) 105, a storage 106, and a switch module 107. In the embodiment, the EPD 103 is an electrophoresis display screen. The LCD screen 101 is regarded as the primary display screen of the electronic device 10, and configured to display a primary user interface to enable operation when the electronic device 10 powers on. The EPD screen 103 is regarded as the auxiliary display screen of the electronic device 10, and configured to display predefined content when the electronic device 10 is powered off. The storage 106 is configured to store the predefined content. For example, when powering on, the electronic device 10 provides controls on the LCD screen 101 allowing content such as user name, event tracking, and others to be preset.

The switch module 107 is configured to power on or power off the electronic device 10 in response to user input, and generate a corresponding control signal, namely, a power off signal or a power on signal, to the CPU 105.

The CPU 105 is configured to register the control signal sent by the switch module 107. When the control signal is the power off signal, the CPU 105 generates a display signal to the EPD control module 104. When receiving the display signal, the EPD control module 104 obtains the predefined content stored in the storage 106, and directs the EPD screen 103 to display the predefined content obtained.

For example, the electronic device 10 can provide controls providing input to the switch module 107. When receiving the power on signal from the switch module 107, the CPU 105 directs the LCD control module 102 to display a user interface on the LCD screen 101, such as a dialog box including a number of available selectable options. Upon receiving a command to power off the electronic device 10 from the switch module 107 generated by control input on the electronic device 10, the CPU 105 generates a selection interface to display the predefined content stored in the storage 106. Via the selection interface, content to be displayed on the EPD screen 103 can be set. When receiving the command to display the predefined content on the EPD screen 103 from a particular control on the electronic device 10, the CPU 105 generates the display signal to the EPD control module 104, and the EPD control module directs the EPD screen 103 to display the selected predefined content. After generating the display signal, the CPU 105 powers the electronic device 10 off. When receiving the command to close the selection interface, the CPU 105 directly powers off the electronic device 10.

Because the EPD screen 103 is bistable, currently displayed content remains viewable even when the device is powered off.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device comprising:
a liquid crystal display (LCD) screen configured to display a primary user interface when the electronic device powers on;
an electronic paper display (EPD) screen configured to display a predefined content set by users when the electronic device powers off;
an EPD control module;
a storage configured to storage the predefined content;
a switch module configured to power on or power off the electronic device in response to user's operations, and generate a corresponding control signal; and
a central processing unit (CPU) configured to generate a display signal to the EPD control module when the control signal is a power off signal;
wherein the EPD control module receives the display signal, obtains the predefined content stored in the storage, and directs the EPD screen to display the predefined content obtained.

2. The electronic device as recited in claim 1, wherein the LCD is a primary display screen of the electronic device, and the EPD is an auxiliary display screen of the electronic device.

3. The electronic device as recited in claim 1, further comprising an LCD control module;
wherein when the control signal is the power off signal, the CPU directs the LCD control module to display a selection interface to display the predefined content on the LCD screen for users to select.

4. The electronic device as recited in claim 3, wherein when receiving a selecting command to display the predefined content on the EPD screen, the CPU generates the display signal to the EPD control module, and the EPD control module directs the EPD screen to display the selected predefined content; after the EPD screen displays the selected predefined content, the CPU controls to power off the electronic device.

5. The electronic device as recited in claim 3, wherein when receiving a command to close the selection interface, the CPU directly controls to power off the electronic device.
